(19) United States
(12) Patent Application Publication
(10) Pub. No.: US 2025/0106344 A1
(43) Pub. Date: Mar. 27, 2025

(54) INFORMATION PROCESSING APPARATUS, METHOD THEREFOR, AND STORAGE MEDIUM

(71) Applicant: CANON KABUSHIKI KAISHA, Tokyo (JP)

(72) Inventor: YUICHIRO SHIBUYA, Kanagawa (JP)

(21) Appl. No.: 18/896,516

(22) Filed: Sep. 25, 2024

(30) Foreign Application Priority Data
Sep. 27, 2023 (JP) 2023-165672

(51) Int. Cl. H04N 1/60

(52) U.S. Cl. CPC H04N 1/6033

(57) ABSTRACT

A method for an information processing apparatus, includes obtaining an execution result of color validation, and displaying an execution schedule of the color validation, wherein, in the displaying, the execution schedule is displayed for a user to identify a color validation result and whether the color validation is executed based on the obtained execution result of the color validation, and the execution schedule is displayed for the user to identify a task in which the color validation has not been executed even though the task has passed a scheduled date and time.

### BACKGROUND

### Field of the Disclosure

The present disclosure relates to a system and an information processing apparatus for performing validation of color quality of a printed material, and a control method for the information processing apparatus.

### Description of the Related Art

It is known that a shift in output color occurs in an image forming apparatus owing to an individual difference, environmental dependence, variations in a physical load of the apparatus, and the like. A color validation is known as a method to be executed to check whether a shift in output color has occurred. In the color validation, a color chart is output from the image forming apparatus, and colorimetry is performed on the color chart using an apparatus called a colorimeter, thereby a shift from an ideal color is measured as a color difference. If the color difference is more than or equal to a predetermined threshold, it is determined that a color shift has occurred, and an operation (e.g., calibration) for adjusting the color output from an image output apparatus is performed in many cases.

In the commercial printing field, color validation is periodically executed in many cases. For example, in a printing office, color validation is performed by an operator at a work starting time to check whether a color shift has occurred in the image forming apparatus. In this case, if a color shift has occurred, calibration or the like is performed to thereby adjust colors output by the image forming apparatus. Japanese Patent Application Laid-Open No. 2023-50739 discusses a technique for performing a series of color validation operations and displaying colorimetry results using a web browser.

For example, there may be a case where an administrator creates an execution schedule to periodically execute color validation as described above and causes an operator to execute the color validation based on the schedule. In this case, it may be desirable for the administrator and the operator to easily recognize a color validation schedule and a color validation status. Accordingly, the present disclosure is directed to providing a method for facilitating a user to recognize a color validation schedule and a color validation status.

### SUMMARY OF THE DISCLOSURE

According to an aspect of the present disclosure, a method for an information processing apparatus, includes obtaining an execution result of color validation, and displaying an execution schedule of the color validation, wherein, in the displaying, the execution schedule is displayed for a user to identify a color validation result and whether the color validation is executed based on the obtained execution result of the color validation, and the execution schedule is displayed for the user to identify a task in which the color validation has not been executed even though the task has passed a scheduled date and time.

Further features of the present disclosure will become apparent from the following description of exemplary embodiments with reference to the attached drawings.

### BRIEF DESCRIPTION OF THE DRAWINGS

FIG. 1 is a block diagram illustrating an entire color validation system according to an exemplary embodiment of the present disclosure.

FIG. 2 is a block diagram illustrating a hardware configuration of each information processing apparatus according to the exemplary embodiment.

FIG. 3 is a block diagram illustrating functions of the color validation system according to the exemplary embodiment.

FIG. 4 illustrates an example of a color validation setting screen according to the exemplary embodiment.

FIG. 5 illustrates settings stored in a colorimetry setting storage unit according to the exemplary embodiment.

FIG. 6 illustrates an example of color patches used for color validation according to the exemplary embodiment.

FIG. 7 is a flowchart illustrating a schedule function according to the exemplary embodiment.

FIG. 8 illustrates a schedule function execution history according to the exemplary embodiment.

FIG. 9 is a flowchart illustrating a colorimetry function and a color validation management function according to the exemplary embodiment.

FIG. 10 illustrates an example of a colorimetry result according to the exemplary embodiment.

FIG. 11 illustrates an example of a color validation calendar screen according to the exemplary embodiment.

FIG. 12 is a flowchart illustrating a color validation calendar screen display function according to the exemplary embodiment.

### DESCRIPTION OF THE EMBODIMENTS

Exemplary embodiments of the present disclosure will be described in detail below with reference to the accompanying drawings. The following exemplary embodiments are not intended to limit the scope of the present disclosure as encompassed by the claims, and not all combinations of features described in the exemplary embodiments are necessarily deemed to be essential. The exemplary embodiments and modified examples to be described below may be selectively combined as needed.

### [System Configuration]

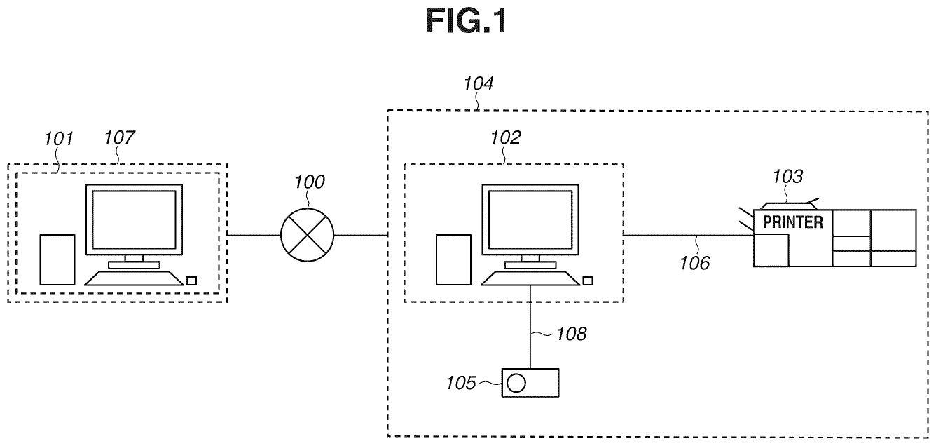

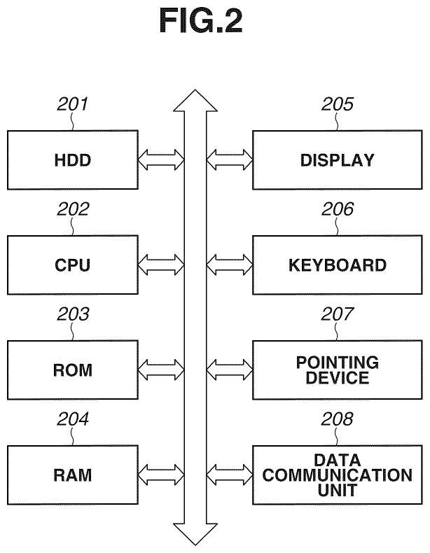

An image forming system, a color validation system, and a hardware configuration according to an exemplary embodiment of the present disclosure will be described with reference to block diagrams FIGS. 1 and 2. FIG. 1 is a block diagram illustrating the color validation system according to the present exemplary embodiment. The color validation system is broadly divided into a web system 107 and a printing business operator system 104. The web system 107 and the printing business operator system 104 are interconnected via a network 100, such as the Internet. The web system 107 includes an information processing apparatus 101. For example, the web system 107 manages and controls image forming apparatuses. The web system 107 may be constructed on a cloud or may be constructed on a company's server.

An internal configuration of the printing business operator system 104 will be described in detail below. As illustrated in FIG. 1, an information processing apparatus 102 and an image forming apparatus 103 having a print function are interconnected via a network 106. The information processing apparatus 102 and a colorimeter 105 are interconnected via a serial bus 108. The image forming apparatus 103 is controlled under a group of programs operating on the information processing apparatus 102, and generates deliverables by processing print settings and print data that have been received from the web system 107.

FIG. 2 is a block diagram illustrating a hardware configuration of each of the information processing apparatuses 101 and 102. Each of the information processing apparatuses 101 and 102 includes a central processing unit (CPU) 202 for performing calculations and a storage unit including a hard disk drive (HDD) 201, a read-only memory (ROM) 203, and a random access memory (RAM) 204. The CPU 202 controls execution of programs that are stored in the storage unit and loaded into the RAM 204. Each of the information processing apparatuses 101 and 102 also includes a display unit, such as a display 205, as an input/output device, an operation reception unit, such as a pointing device 207 and a keyboard 206, and a data communication unit 208 as a set of controller devices to manage a network and a data bus on hardware. Examples of the information processing apparatuses 101 and 102 include a personal computer (PC), a smartphone, and a tablet terminal. The information processing apparatuses 101 and 102 are configured to communicate data mutually via various controllers or busses in the information processing apparatuses 101 and 102. The image forming apparatus 103 has a configuration similar to that of the information processing apparatuses 101 and 102. In addition to this configuration, however, the image forming apparatus 103 also includes a printer engine and a scanner.

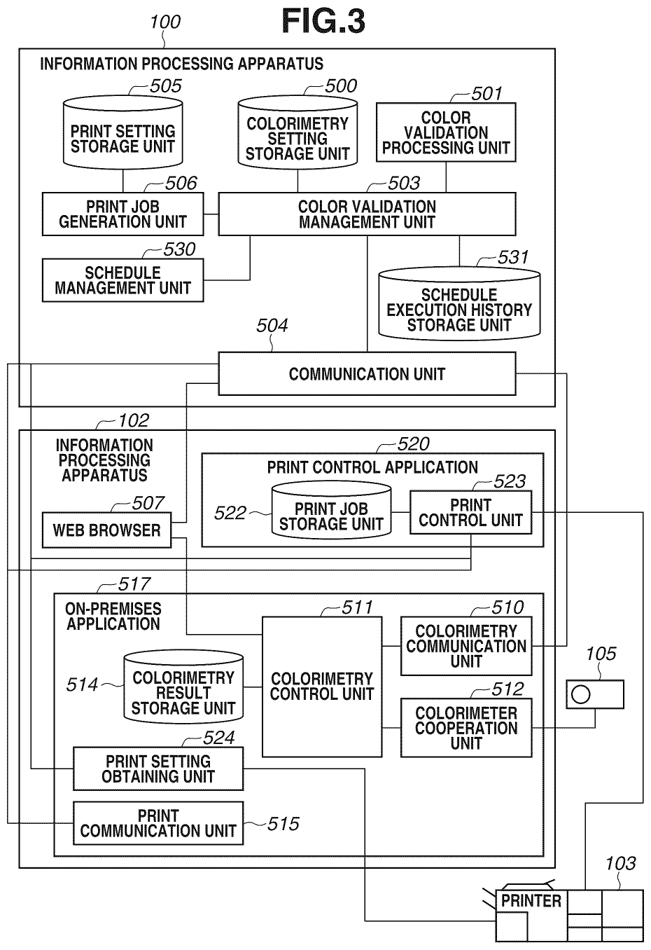

FIG. 3 is a block diagram illustrating functions included in the web system 107 and the printing business operator system 104 that constitute the color validation system according to the present exemplary embodiment. These functions are implemented by the CPU executing the programs stored in the storage unit.

First, functional blocks included in the information processing apparatus 102 of the printing business operator system 104 will be described. The information processing apparatus 102 includes a web browser 507, a print control application 520, an on-premises application 517, and a print communication unit 515.

The web browser 507 communicates with a communication unit 504 to obtain a content, such as a web content. Further, the web browser 507 parses an obtained content and displays the content. The web browser 507 is configured to execute processing on programs described in a programming language, such as JavaScript.

The on-premises application 517 is an application having a role of relaying access between the web system 107, the image forming apparatus 103, the colorimeter 105, and the web browser 507. For example, when a chart is to be printed, the web system 107 relays the on-premises application 517 to print the chart on the image forming apparatus 103. When colorimetry of the printed chart is performed, the colorimeter 105 is controlled via the on-premises application 517. The web browser 507 receives an instruction to create a color validation test or a measurement instruction, and displays a result, such as a color validation result.

A colorimetry control unit 511 receives an instruction from the web browser 507 and controls the colorimeter 105 via a colorimeter cooperation unit 512. The colorimetry control unit 511 stores a reading result in a colorimetry result storage unit 514. Upon receiving a colorimetry complete instruction from the web browser 507, the colorimetry control unit 511 receives a colorimetry result that matches an identification (ID) included in the colorimetry complete instruction from the colorimetry result storage unit 514, and transmits the colorimetry result to the communication unit 504 via a colorimetry communication unit 510.

The colorimetry communication unit 510 establishes communication between the colorimetry control unit 511 and the communication unit 504. Upon receiving the colorimetry result from the colorimetry control unit 511, the colorimetry communication unit 510 starts communication with the communication unit 504 and transmits the colorimetry result to the communication unit 504. A communication method to be used is not particularly limited. In the present exemplary embodiment, HyperText Transfer Protocol (HTTP) communication is used.

The colorimeter cooperation unit 512 is an interface with the colorimeter 105, and mediates communication between the colorimetry control unit 511 and the colorimeter 105.

The print communication unit 515 establishes communication between a print control unit 523 and the communication unit 504. When a print instruction is issued by a user, the print communication unit 515 receives a print job including print settings and print data from the communication unit 504, also receives an Internet Protocol (IP) address of the destination image forming apparatus, and delivers the IP address to the print control unit 523.

The print control application 520 is a print management application for printing a document of a portable document format (PDF) or the like or an image of a Joint Photographic Experts Group (JPEG) format or the like, and includes the print control unit 523 and a print job storage unit 522. The print control application 520 is configured to receive a print command from an external apparatus and transmit the print command to the image forming apparatus 103 via the print control unit 523. The user can use the print control application 520 to manage printing using the image forming apparatus 103. The operation of the print control application 520 will be described in detail below.

A print setting obtaining unit 524 requests the print control unit 523 in the print control application 520 to make print settings for the print job, and obtains the print settings for the print job. If the image forming apparatus 103 has a print job management function similar to that of the print control application 520, the print setting obtaining unit 524 requests the image forming apparatus 103 to make print settings for the print job, and obtains the print settings for the print job.

The colorimetry result storage unit 514 is a location where a colorimetry result of a chart for colorimetry is stored by the colorimetry control unit 511 when colorimetry of the chart for colorimetry is completed. The colorimetry result storage unit 514 stores the colorimetry result as a file in the storage unit, such as the HDD 201 of the information processing apparatus 102.

The print job storage unit 522 is a location where a print job created by the print control application 520 and a colorimetry color chart print job are stored. The print job storage unit 522 stores each print job as a file in the storage unit, such as the HDD 201, of the information processing apparatus 102. The information processing apparatus 102 includes the functional blocks as described above.

Next, functional blocks included in the information processing apparatus 101 of the web system 107 will be described. The communication unit 504 is a service program that establishes HTTP communication with the web browser 507 to provide the web browser 507 with display of a Hypertext Markup Language (HTML) and an object (e.g., image). The communication unit 504 establishes HTTP communication with the print communication unit 515 and transmits a print job to the on-premises application 517. Further, the communication unit 504 establishes HTTP communication with the colorimetry communication unit 510 and receives the colorimetry result of the color chart from the colorimetry control unit 511.

A schedule management unit 530 transmits an email to a registered email address of the user via the communication unit 504 at time when color validation is reserved based on a schedule setting stored in a colorimetry setting storage unit 500. After the email is transmitted, the schedule management unit 530 stores a schedule execution history in a schedule execution history storage unit 531.

A color validation management unit 503 is a function for controlling execution of each process in a color validation processing.

Based on a user instruction input via the web browser 507, the color validation management unit 503 executes processing including chart printing, colorimetry, and color validation. The colorimetry result received by the communication unit 504 is also stored in the colorimetry result storage unit 514.

The colorimetry setting storage unit 500 is a location where a colorimetry setting input by the user is stored. When the user inputs and stores the colorimetry setting on the web browser 507, the web browser 507 delivers the colorimetry setting to the communication unit 504. An input of the colorimetry setting and a colorimetry setting screen will be described below. When the communication unit 504 receives the colorimetry setting, the color validation management unit 503 stores the received colorimetry setting in the colorimetry setting storage unit 500.

A print job generation unit 506 has a function of generating print settings and print data. Specifically, the user issues a print instruction on the web browser 507. When the print instruction is issued, the web browser 507 transmits the print instruction to the communication unit 504. When the communication unit 504 delivers the print instruction to the color validation management unit 503, the color validation management unit 503 obtains a colorimetry setting based on an identifier (e.g., 00001) designated by the print instruction from the colorimetry setting storage unit 500.

The color validation management unit 503 delivers the obtained colorimetry setting to the print job generation unit 506. The print job generation unit 506 generates a print job including chart print settings and print data that satisfy the colorimetry setting. The print job generation unit 506 stores the generated print job in a print setting storage unit 505. The print setting storage unit 505 stores the print job as a file in the storage unit, such as the HDD 201, of the information processing apparatus 101. The generation of a print job is executed based not only on a print instruction issued by the user, but also on a print instruction issued by a scheduling function, or at a timing when a colorimetry setting is stored in the colorimetry setting storage unit 500.

### <Description of Print Control Application 520>

The operation of the print control application 520 will be described. The print control application 520 manages and controls printing using the image forming apparatus 103 and a print schedule using a print job. The print control application 520 stores print setting information and the like on the print job executed by the image forming apparatus 103 as history information, and manages print jobs to be executed. In general, a shipping schedule of each product, or printed material, is set in each printing office, and printing processes are arranged based on the schedule in many cases. The print control application 520 is also used to create printing processes based on a schedule as described above. The print control application 520 includes an interface for receiving a print command from an external application, and is configured to transmit the print command received via the print control unit 523 to the image forming apparatus 103. Further the print control application 520 includes an interface for returning a print schedule or a print job execution history in a format (e.g., JavaScript Object Notation (JSON) format) that can be interpreted by another application in response to a request. For example, upon receiving a print job from the print communication unit 515, the print control unit 523 transmits the print job to the image forming apparatus 103 corresponding to the IP address included in the received information. It is assumed that HTTP communication is used as a print job transmission method in the present exemplary embodiment. However, the print job transmission method is not particularly limited. Any other print job transmission method, such as universal serial bus (USB) communication or Hot Folder, may be used.

### <Setting Screen>

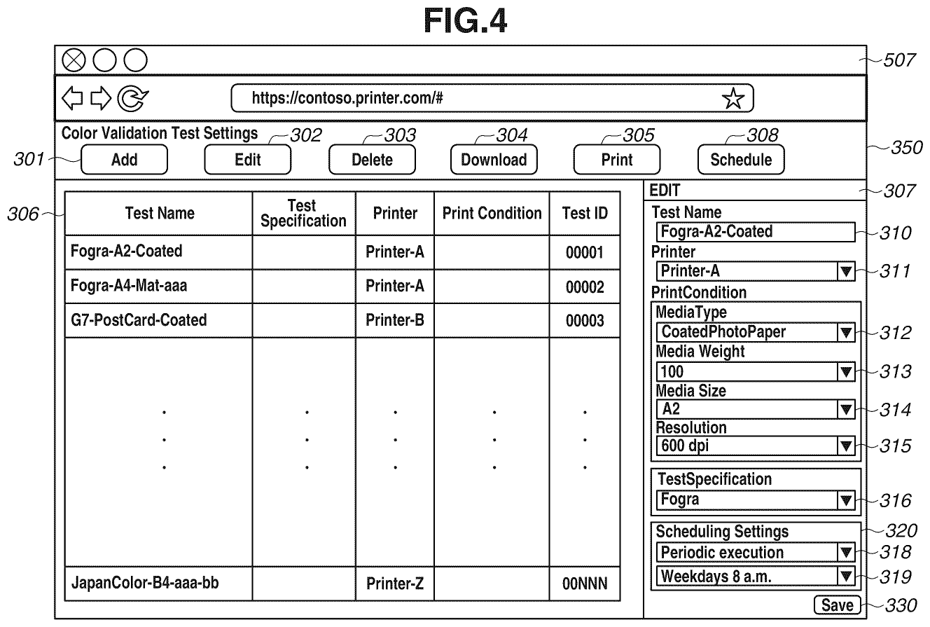

FIG. 4 illustrates an example of a color validation setting screen to be displayed on the web browser 507.

A display area 350 is an area to display a web page content. A colorimetry setting list 306 includes a color validation list to be used for color validation, and some of the settings to be used for the color validation are displayed together with setting item names. Each row indicates one setting. A colorimetry setting add button 301 is a button for adding a new colorimetry setting to the colorimetry setting list 306. When the colorimetry setting add button 301 is pressed by the user, a colorimetry setting edit area 307 is displayed, and the user can input information to be used for creation.

A colorimetry setting edit button 302 is a button for the user to edit or change a colorimetry setting that is already present in the colorimetry setting list 306. When the user selects a setting displayed in the colorimetry setting list 306 and presses the colorimetry setting edit button 302, the colorimetry setting edit area 307 is displayed, which enables the user to change the selected colorimetry setting.

A colorimetry setting delete button 303 is a button for the user to delete a colorimetry setting that is already present in the colorimetry setting list 306. When the user selects a setting displayed on the colorimetry setting list 306 and presses the colorimetry setting delete button 303, the color validation management unit 503 deletes the designated colorimetry setting from the colorimetry setting storage unit 500.

A print data download button 304 is a button for downloading chart print data into a designated local folder. For example, if color validation is to be performed on an image forming apparatus that is not supported by the color validation system, the color validation system cannot execute printing on the image forming apparatus in some cases. For this reason, the chart print data is downloaded into a local folder once, and the downloaded print data can be printed using a printer driver.

A print button 305 is a button for directly sending a chart print instruction to the image forming apparatus 103 from the web system 107. For example, when the print button 305 is pressed, the web browser 507 transmits a print instruction corresponding to the selected colorimetry setting to the communication unit 504, and the communication unit 504 delivers the print instruction to the color validation management unit 503. The print job generation unit 506 generates a print job including chart print settings and print data that satisfy the colorimetry setting. Further, the print job generation unit 506 delivers the generated print job to the color validation management unit 503. The color validation management unit 503 transmits the print job and the IP address of the image forming apparatus 103 to the on-premises application 517 via the communication unit 504. The on-premises application 517 transmits the print job to the image forming apparatus 103. The image forming apparatus 103 outputs a printed material based on the print job. The user performs colorimetry and color validation on the chart that is the output printed material.

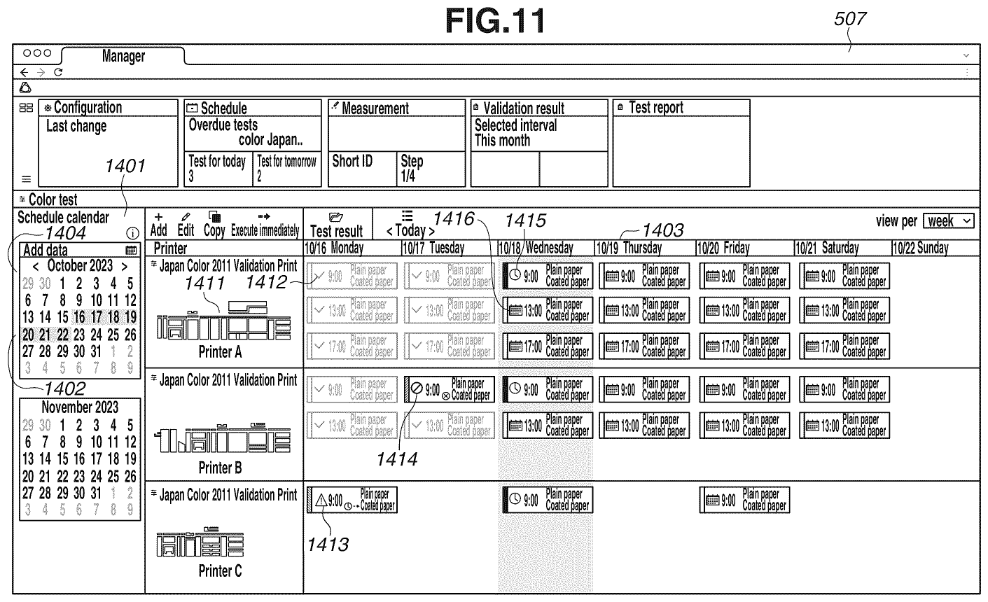

A schedule display button 308 is a button for displaying a calendar for displaying a scheduled color validation list. When the user presses the schedule display button 308, a calendar display screen 1401 illustrated in FIG. 11 is displayed, which enables the user to check the scheduled color validation. The calendar display function will be described below. The calendar display screen 1401 enables the user not only to check the color validation schedule, but also to perform an operation for issuing a colorimetry instruction in color validation and receive an instruction to display a colorimetry result.

A colorimetry setting save button 330 is a button for storing colorimetry settings that are edited or made on the colorimetry setting edit area 307. When the colorimetry setting save button 330 is pressed, the color validation management unit 503 communicates with the communication unit 504 via the web browser 507 to assign an identifier (e.g., 000001) to the colorimetry setting, and stores the colorimetry setting in a JSON format, which is generally used in a web system, in the colorimetry setting storage unit 500.

### <Description of Items on Edit Screen>

Each setting item on the colorimetry setting edit area 307 will be described.

A setting item 310 is a setting item for designating a colorimetry setting name. The user can set any name in the setting item 310.

A setting item 311 is a setting item for designating a printer for executing colorimetry. The user can select any of the printers connected to the on-premises application 517.

Setting items 312, 313, 314, and 315 are setting items for making print settings to be used for colorimetry. The user can set a sheet type in the setting item 312, can set the grammage of a sheet in the setting item 313, can set a sheet size in the setting item 314, and can set a resolution in the setting item 315. As the items to be selected, the on-premises application 517 may have prescribed types of setting items, or preset setting items. The items may also be generated based on capability information about each image forming apparatus obtained using the print control unit 523 or the printer driver.

A setting item 316 is an item for selecting a color reference to be used for colorimetry. In the setting item to be displayed, a standard printing color reference or a user-defined printing color reference may be displayed. As the standard printing color reference, for example, a color reference, such as GRACOL of the United States, FOGRA of Europe, and Japan Color of Japan, exists for each region. The format of a chart to be used for colorimetry and a layout of a color patch to be used for the chart are determined based on the color reference selected by the setting item 316.

Setting items 318, 319, and 320 are setting items for the scheduling function. The user can execute color validation periodically or at an automatically designated time by using the setting items in combination. For example, when the user selects “periodic execution” in the setting item 318 and sets “weekdays 8:00” in the setting item 319, color validation is periodically executed at 8:00 a.m. on weekdays.

### <Description of Colorimetry Setting Stored in Colorimetry Setting Storage Unit 500>

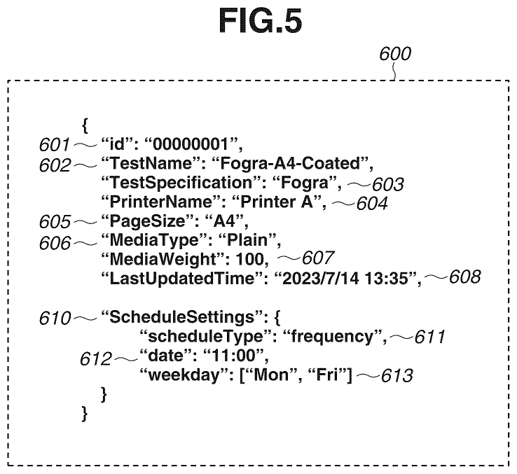

A colorimetry setting to be stored in the colorimetry setting storage unit 500 when the user presses the colorimetry setting save button 330 on the colorimetry setting edit area 307 will be described with reference to FIG. 5. FIG. 5 illustrates an example of the colorimetry setting. Character strings 600 indicate all setting values for the colorimetry setting and are stored in a JSON format. A character string 608 indicates a last update date of the setting values. A character string 601 indicates an ID for identifying the color validation to which the setting values are applied, and “00000001” is set. A character string 602 indicates the name of color validation, and “Fogra-A4-Coated” is set. A character string 603 indicates the type of color validation reference to be used for color validation, and “Fogra” is set. A character string 604 indicates the name of an image forming apparatus to be used for color validation, and “Printer A” is set. A character string 605 indicates a sheet size, and “A4” is set. A character string 606 indicates a sheet type, and plain paper is set. A character string 607 indicates the grammage of sheets, and “100” is set. A character string 610 indicates an identifier representing a set of schedule settings. A character string 611 indicates a format in which the schedule setting is to be executed. For example, when “frequency” is set as the character string 611, the schedule setting is periodically executed every week. A character string 612 indicates time when the color validation is to be executed, and “11:00” is set. A character string 613 indicates a day of the week when the color validation is executed, and “Monday” and “Friday” are set.

### <Description of Color Chart>

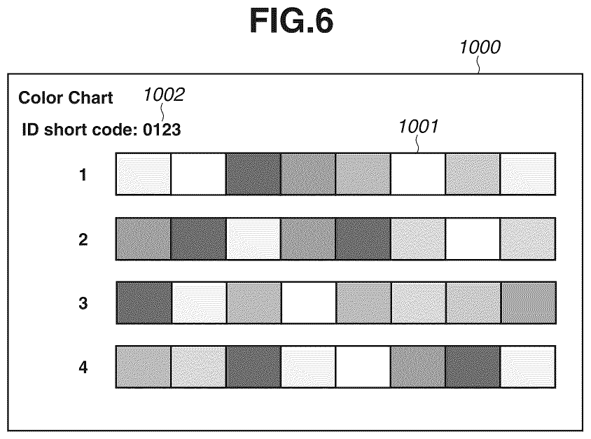

FIG. 6 illustrates an example of a color chart to be printed during the color validation. When a print job for the color validation is set, a color chart 1000 is printed according to print settings included in the print job. The color chart 1000, in which a plurality of rows of color patches 1001 is arranged, is printed. The layout and color type of each of the color patches 1001 vary depending on the type of color validation reference. The user performs colorimetry on each of the color patches 1001 in the printed color chart 1000 using the colorimeter 105, thereby reading colors. The read colors are processed by the color validation management unit 503, and a difference between a read value and each color patch value defined in the color reference is obtained. A short ID 1002 is an ID for associating the color chart with the color validation stored in a colorimetry setting storage unit 500. The user inputs the short ID 1002 to the on-premises application 517 and transmits a colorimetry result to the communication unit 504 via the web browser 507. The color validation management unit 503 stores the colorimetry result in association with the colorimetry setting in the colorimetry setting storage unit 500. Detailed descriptions of the processing are omitted in the present exemplary embodiment.

### <Description of Schedule Function>

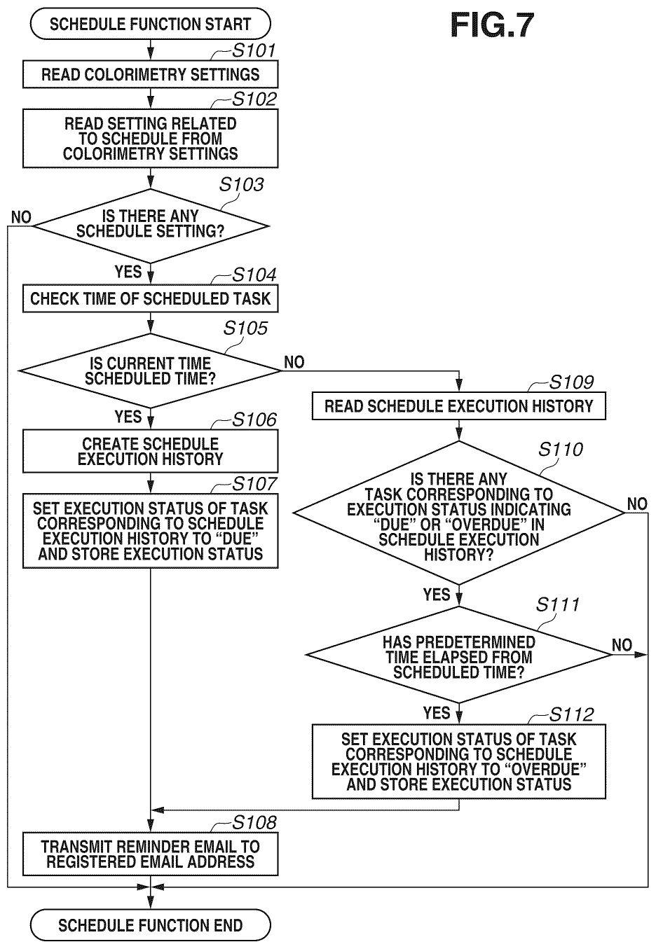

A schedule management function according to the present exemplary embodiment will be described with reference to FIG. 7. The schedule management unit 530 executes processing to be described below periodically (e.g., every one minute), thereby implementing the schedule management function.

In step S101, the schedule management unit 530 reads colorimetry settings stored in the colorimetry setting storage unit 500, and then the processing proceeds to step S102. In step S102, the schedule management unit 530 reads a setting related to the schedule from the colorimetry settings, and then the processing proceeds to step S103. In step S103, the schedule management unit 530 determines whether there is a schedule setting in the setting related to the schedule. If the schedule management unit 530 determines that there is a schedule setting (YES in step S103), the processing proceeds to step S104. If the schedule management unit 530 determines that there is no schedule setting (NO in step S103), the processing ends. In this step, it is determined whether there is the color validation schedule setting set by an administrator or the like operating the colorimetry setting edit area 307.

In step S104, the schedule management unit 530 checks the time of each scheduled task with reference to the schedule setting, and then the processing proceeds to step S105. The term “task” as used herein refers to a series of color validation processes including chart printing, colorimetry, and validation. Color validation is executed once in one task. In step S105, the schedule management unit 530 determines whether the current time is a scheduled time in any of the tasks checked in step S104. If the current time is the scheduled time (YES in step S105), the processing proceeds to step S106. If the current time is not the scheduled time (NO in step S105), the processing proceeds to step S109.

When the scheduled time is reached, in step S106, the schedule management unit 530 creates a schedule execution history to be described below, and then the processing proceeds to step S107. After the schedule execution history is created, in step S107, the schedule management unit 530 sets an execution status of the task corresponding to the schedule execution history to “due” and stores the execution status in association with the colorimetry setting in the schedule execution history storage unit 531. Then, the processing proceeds to step S108. In step S108, an email is automatically transmitted to a pre-registered email address of the user stored in the colorimetry setting storage unit 500, and then the processing ends. In this case, for example, an email is transmitted to an operator of the image forming apparatus, and the operator executes the color validation.

If the current time is not the scheduled time in step S105, in step S109, the schedule management unit 530 reads the schedule execution history stored in the schedule execution history storage unit 531. Then, the processing proceeds to step S110. In step S110, the schedule management unit 530 checks and determines whether there is a task with the execution status indicating “due” or “overdue” in the execution history. The execution status “due” indicates a case where the set date and time in the schedule have passed, and the execution status “overdue” indicates a case where the color validation has not been executed for a predetermined period from the time when “due” is set. In step S110, if it is determined that there is a schedule execution history including the execution status indicating “due” or “overdue” (YES in step S110), the processing proceeds to step S111. If it is determined that there is no schedule execution history including the execution status indicating “due” or “overdue” (NO in step S110), the processing ends. In step S111, the schedule management unit 530 checks the current time and determines whether there is a schedule execution history including the execution status indicating “due” or “overdue” and whether a predetermined period has elapsed from the set date and time. If there is such a schedule execution history (YES in step S111), the processing proceeds to step S112. If there is no such schedule execution history (NO in step S111), the processing ends. If there is such a schedule execution history (YES in step S111), in step S112, the schedule management unit 530 sets the execution status of the task corresponding to the schedule execution history to “overdue” and stores the execution status in the schedule execution history storage unit 531. Then, the processing proceeds to step S108. If the user receives an email in the above-described processing flow, the web system 107 executes chart printing as well as colorimetry and validation on the printed chart separately from the above-described processing flow.

### <Description of Schedule Execution History>

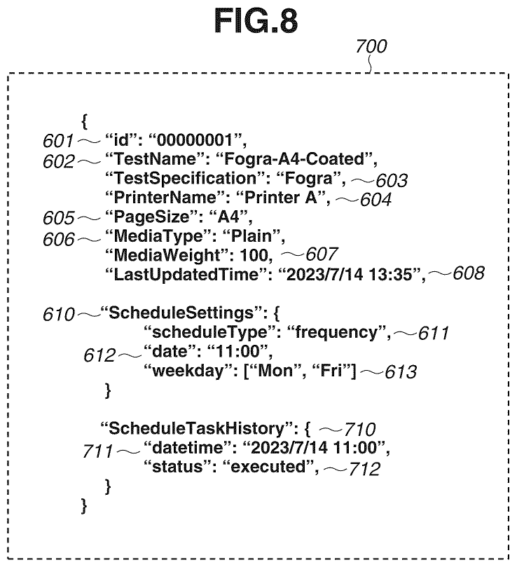

An example of the schedule execution history stored in the schedule management unit 530 will be described with reference to FIG. 8. FIG. 8 illustrates an example of a schedule execution history 700 generated through, for example, the processing in step S302 to be described below.

The character strings 601 to 613 are identical to those in the colorimetry setting illustrated in FIG. 5, and thus descriptions thereof are omitted. A character string 710 indicates an identifier representing a set of schedule execution histories. A character string 711 indicates a date and time when a schedule is executed, and “2023 Jul. 14 11:00” is set. A character string 712 indicates a schedule execution status, and “executed” is set to indicate that the color validation is completed. Examples of the schedule execution status include not only “executed” described above, but also “due” and “overdue”. In the schedule function according to the present exemplary embodiment, the schedule for the entire color validation processing (chart printing, colorimetry, and validation) is managed as one task. However, the schedule function is not limited thereto. For example, an intermediate state, such as a state where chart printing has been executed but colorimetry has not been executed yet, in the color validation processing may be managed as the execution status.

### <Description of Color Validation Function>

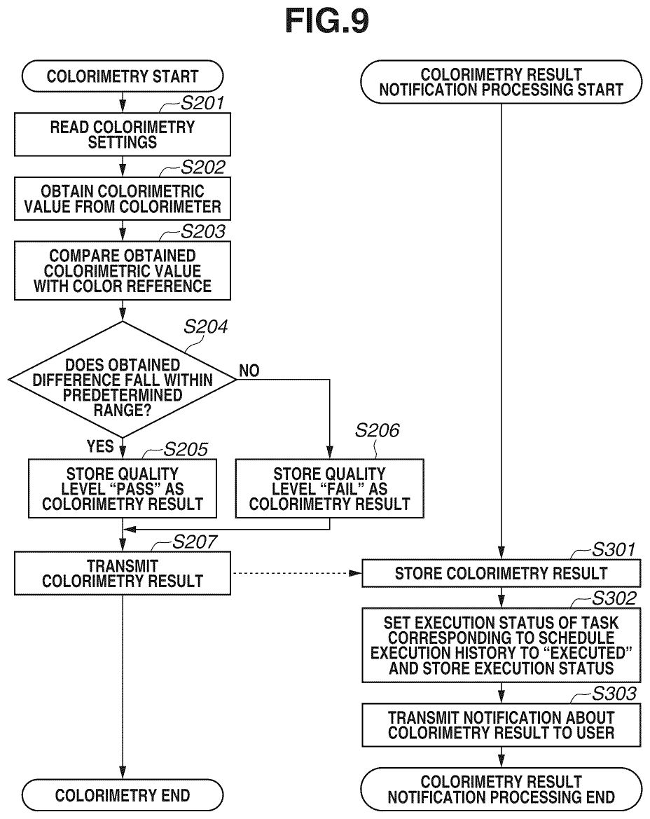

A color validation function according to the present exemplary embodiment will be described with reference to a flowchart illustrated in FIG. 9. When the user issues a colorimetry start instruction via the web browser 507, in step S201, the on-premises application 517 reads colorimetry settings from the colorimetry setting storage unit 500 via the web browser 507 and the communication unit 504, and then the processing proceeds to step S202. The user performs colorimetry on each of the color patches 1001 in the printed color chart 1000 using the colorimeter 105, and reads a colorimetric value. In step S202, the color validation management unit 503 obtains the colorimetric value from the colorimeter 105, and then the processing proceeds to step S203. In step S203, the color validation management unit 503 obtains a difference between the obtained colorimetric value of each color patch 1001 and the value of each color patch defined in the color reference, and then the processing proceeds to step S204.

In step S204, the color validation management unit 503 checks whether the difference obtained in step S203 falls within a predetermined range. In this step, the color validation management unit 503 may check whether differences corresponding to all the color patches 1001 fall within the predetermined range, and in addition, may also check whether the sum of the differences corresponding to all the color patches 1001 is less than or equal to a threshold. In other words, the color validation management unit 503 may check whether the image forming apparatus is performing appropriate color output.

If it is determined that the difference falls within the predetermined range (YES in step S204), i.e., if the color chart 1000 has passed the color validation, the processing proceeds to step S205. If it is determined that the difference does not fall within the predetermined range (NO in step S204), i.e., if the color chart 1000 has failed the color validation, the processing proceeds to step S206. If the difference falls within the predetermined range, in step S205, the color validation management unit 503 sets a quality level to “Pass” and stores the colorimetry result in the colorimetry result storage unit 514. Then, the processing proceeds to step S207. If the difference does not fall within the predetermined range, in step S206, the color validation management unit 503 sets the quality level to “Fail” and stores the colorimetry result in the colorimetry result storage unit 514. Then, the processing proceeds to step S207. The on-premises application 517 transmits the colorimetry result to the color validation management unit 503 via the web browser 507 and the communication unit 504, and then the colorimetry processing ends.

Upon receiving the colorimetry result transmitted in step S207, in step S301, the color validation management unit 503 stores the colorimetry result in association with the colorimetry setting in the colorimetry setting storage unit 500, and then the processing proceeds to step S302. In step S302, the schedule management unit 530 sets the execution status of the schedule execution history stored in the schedule execution history storage unit 531 to “executed” and stores the execution status. Then, the processing proceeds to step S303. In step S303, the color validation management unit 503 automatically transmits an email to the pre-registered email address of the user stored in the colorimetry setting storage unit 500 to notifies the user of the color validation result, and then the processing ends.

### <Description of Colorimetry Result Stored in Colorimetry Result Storage Unit 514>

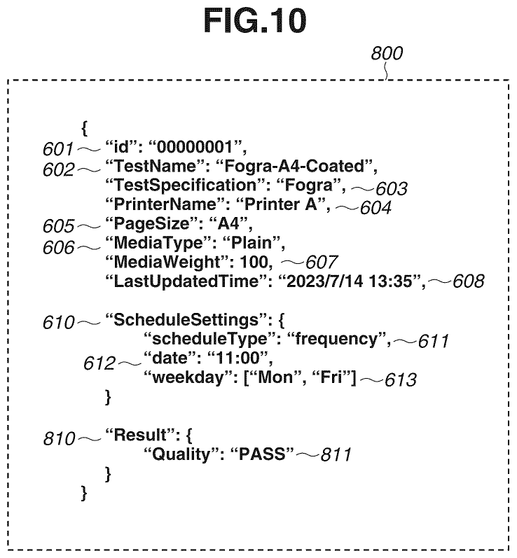

The colorimetry result stored in the colorimetry result storage unit 514 will be described with reference to FIG. 10.

FIG. 10 illustrates an example of the colorimetry result that is generated through, for example, processing of steps S205 and S206. Character strings 800 indicate the entire colorimetry result and are stored in a JSON format.

The character strings 601 to 613 are identical to those in the colorimetry setting, and thus descriptions thereof are omitted. A character string 810 indicates an identifier representing a set of colorimetry results. A character string 811 indicates a color validation result, and “Pass” indicating that the result is a pass is set. Examples of the color validation result include not only “Pass”, but also “Fail” indicating that the result is a fail. While the present exemplary embodiment illustrates the example where the result is indicated as either “Pass” or “Fail”, a colorimetric value of each color patch or the difference may also be displayed.

### <Description of Schedule Calendar Screen>

A calendar for the user to check the set color validation schedule and setting status is displayed on the web browser 507. FIG. 11 illustrates a state where the calendar is displayed on the web browser 507 by the calendar display function. Each task of the scheduled color validation is displayed on the calendar. A date and time of each task, information indicating whether to execute the task, and an execution result are also displayed.

The calendar display screen 1401 includes a calendar screen 1404 on a left side in the screen, and a schedule/actual performance/result display screen 1403 on a right side in the screen for displaying a schedule, an actual performance, and a result corresponding to the date selected on the calendar screen 1404 in chronological order for each image forming apparatus. When the user selects a date portion 1402 (e.g., October 16), which is a date on the calendar, the screen is changed to display the schedule/actual performance/result display screen 1403 corresponding to the selected date portion 1402. For example, the color validation schedule, the actual performance, and the result for one week from the selected date are displayed. An image forming apparatus icon 1411 indicates an image forming apparatus with a color validation schedule, an actual performance, and a result. Icons indicating the color validation schedule, the actual performance, and the result of the corresponding image forming apparatus are displayed in chronological order on the right of the image forming apparatus icon 1411. A group of icons indicating the schedule, the actual performance, and the result represents one color validation task. For example, Printer A is scheduled to perform the color validation at 9, 13, and 17 o'clock on October 16. A color validation pass icon 1412 indicates that a result of the executed color validation is a pass. The time when the color validation is executed, the type of a sheet used to execute the color validation, and an icon indicating the pass are displayed. The color validation pass icon 1412 can be grayed out so that the icon can be distinguished from other icons. A color validation not-executed icon 1413 indicates that the color validation has not been executed although a scheduled date and time has passed, and the time, the type of a sheet used to execute the color validation, and an icon indicating that the color validation has not been executed are displayed. A color validation fail icon 1414 indicates that the result of the executed color validation is a fail, and the time, the type of a sheet used to execute the color validation, and an icon indicating the fail are displayed. A color validation scheduled time arrival icon 1415 indicates that a scheduled date and time is reached, and the time, the type of a sheet used to execute the color validation, and an icon indicating that the scheduled date and time is reached are displayed. In other words, the color validation scheduled time arrival icon 1415 indicates a task in which the color validation is to be executed at the present time. A color validation schedule icon 1416 indicates that a color validation task whose scheduled date and time is not passed yet is set, and the time, the type of a sheet used to execute the color validation, and an icon indicating that the color validation is scheduled are displayed. The execution schedule described herein is created and managed by, for example, an administrator. The administrator creates a schedule by setting a date and time for a color validation task to be executed, the type of a sheet used to execute the color validation, and other settings. When the color validation pass icon 1412 or the color validation fail icon 1414 is selected by the user, advanced settings and a result of the corresponding color validation task may be displayed. When the color validation not-executed icon 1413, the color validation scheduled time arrival icon 1415, or the color validation schedule icon 1416 is selected by the user, advanced settings for the corresponding color validation task may be displayed, and a color validation execution instruction may be issued on a displayed advanced settings screen.

### <Description of Calendar Display Function>

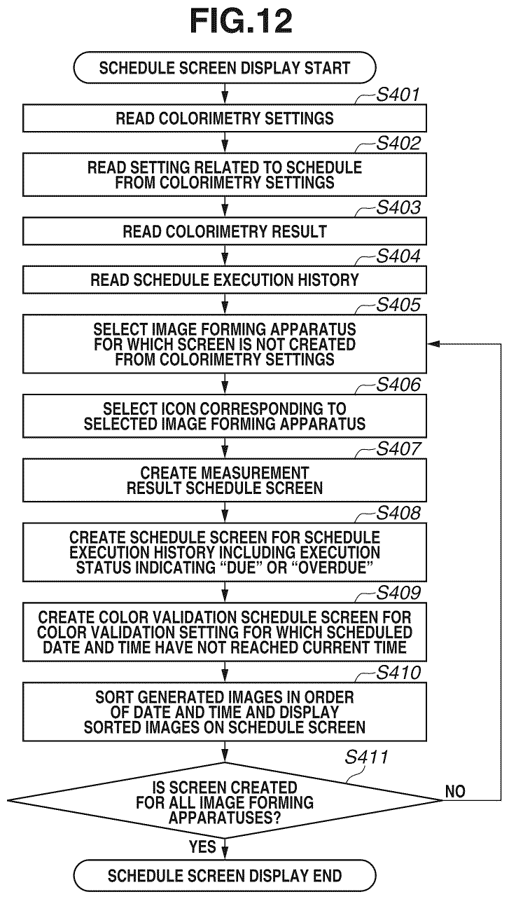

A calendar screen display function according to the present exemplary embodiment will be described with reference to a flowchart illustrated in FIG. 12. Display of the calendar as illustrated in FIG. 11 can be implemented through processing in this flowchart.

If the user selects the date portion 1402 (e.g., July 3), which is a date on the calendar, the web browser 507 starts the calendar display function corresponding to the selected date portion 1402. In step S401, the schedule management unit 530 reads colorimetry settings stored in the colorimetry setting storage unit 500, and then the processing proceeds to step S402. In step S402, the schedule management unit 530 reads a setting related to the schedule from the colorimetry settings, and then the processing proceeds to step S403. In step S403, the schedule management unit 530 reads a measurement result stored in the colorimetry setting storage unit 500 via the color validation management unit 503, and then the processing proceeds to step S404. In step S404, the schedule management unit 530 reads a schedule execution history stored in the schedule execution history storage unit 531 via the color validation management unit 503, and then the processing proceeds to step S405.

In step S405, the schedule management unit 530 selects an image forming apparatus for which the screen is not created from among the image forming apparatuses set in the colorimetry settings, and then the processing proceeds to step S406. In step S406, the schedule management unit 530 preliminarily holds icons corresponding to image forming apparatuses available in this system and selects the icon corresponding to the image forming apparatus selected in step S405, and then the processing proceeds to step S407.

In step S407, the schedule management unit 530 extracts a measurement result within the range of a selected date in the measurement result in which the image forming apparatus is set, and generates a measurement result schedule screen. If the quality level in the colorimetry result indicates “PASS” in step S205 illustrated in FIG. 9, the measurement result schedule screen is generated using the color validation pass icon 1412. If the quality level in the colorimetry result indicates “Fail” in step S206 illustrated in FIG. 9, the measurement result schedule screen is generated using the color validation fail icon 1414. After the measurement result schedule screen is generated, the processing proceeds to step S408.

In step S408, the schedule management unit 530 extracts the schedule execution history including the execution status indicating “due” or “overdue” within the range of the selected date in the schedule execution history in which the image forming apparatus is set, and generates a color validation not-executed schedule screen.

In step S107 illustrated in FIG. 7, if the execution status of the schedule execution history indicates “due”, the color validation not-executed schedule screen is generated using the color validation scheduled time arrival icon 1415. If the execution status of the schedule execution history indicates “overdue” in step S112 illustrated in FIG. 7, the color validation not-executed schedule screen is generated using the color validation not-executed icon 1413. After the color validation not-executed schedule screen is generated in step S408, the processing proceeds to step S409.

In step S409, the schedule management unit 530 extracts color validation settings in which the scheduled date and time is not reached yet and is within the range of the selected date in the color validation settings in which the image forming apparatus is set, and generates a color validation schedule screen. In step S409, the color validation schedule screen is generated using the color validation schedule icon 1416, and then the processing proceeds to step S410.

In step S410, the schedule management unit 530 sorts the generated screens in order of date and time and generates a schedule screen. Then the processing proceeds to step S411. In step S411, the schedule management unit 530 determines whether the screen is created for all the image forming apparatuses set in the colorimetry settings. If there is an image forming apparatus s for which the screen is not created (NO in step S411), the processing returns to step S405. If the screen is created for all the image forming apparatuses set in the colorimetry settings (YES in step S411), the processing ends. The screen generated by the schedule management unit 530 is displayed using the web browser 507.

According to the configuration described above, from an operation schedule on color validation in chronological order, the user can simultaneously check whether an operation has been executed and an operation execution result, thereby the user can easily check the operation result as well as the operation execution status.

Further, according to the configuration described above, if the color validation has already been executed, the operation execution result can be displayed without information indicating whether to execute the operation being displayed. Thus, the user can easily check the color validation result as well as the color validation execution status within a limited display range.

Furthermore, according to the configuration described above, the operation schedule can be displayed for each apparatus, which enables the user to check the operation schedule for each apparatus.

In the description of the schedule function described above, an email is automatically transmitted to a user's email address and the user manually performs the color validation. However, if the image forming apparatus includes a color validation automatic execution function, the color validation may be automatically executed at a scheduled time. In such a configuration, if the image forming apparatus cannot automatically execute the color validation due to a power-off state, an out-of-paper state, or the like of the image forming apparatus, the execution status of the schedule execution history is not changed to “executed” and remains to be “due”. Accordingly, after a lapse of a predetermined period from the scheduled time, the schedule management unit 530 automatically transmits an email to the user's email address using the schedule function. This function makes it possible to prompt the user to manually perform the color validation if the image forming apparatus configured to automatically execute the color validation cannot automatically execute the color validation.

A storage medium storing a program code of software for implementing the above-described functions may be supplied to a system or an apparatus, and a computer (CPU or micro processing unit (MPU)) in the system or the apparatus may read and execute the program code stored in the storage medium. In this case, the program code read from the storage medium implements the functions according to the exemplary embodiments described above, and the storage medium storing the program code constitutes the above-described apparatus.

Examples of the storage medium used to supply the program code include a flexible disk, a hard disk, an optical disk, a magneto-optical disk, a compact disc (CD)-ROM, a CD-recordable (R), a magnetic tape, a nonvolatile memory card, a ROM, and a digital versatile disc (DVD).

The above-described functions may be implemented by the computer executing the read program code, and the above-described functions may also be implemented such that an operating system (OS) running on the computer performs part or all of actual processing based on an instruction from the program code.

Further, the program code read from the storage medium may be written into a function extension board incorporated in the computer or may be written into a memory included in a function extension unit connected to the computer.

Furthermore, the above-described functions may be implemented such that a CPU included in the function extension board or the function extension unit executes part or all of the actual processing based on an instruction from the program code.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-165672, filed Sep. 27, 2023, which is hereby incorporated by reference herein in its entirety.

What is claimed is:

1. A method for an information processing apparatus, comprising:
obtaining an execution result of color validation; and
displaying an execution schedule of the color validation,
wherein, in the displaying, the execution schedule is displayed for a user to identify a color validation result and whether the color validation is executed based on the obtained execution result of the color validation, and the execution schedule is displayed for the user to identify a task in which the color validation has not been executed even though the task has passed a scheduled date and time.

2. The method according to claim 1, wherein the execution schedule is displayed such that a plurality of scheduled color validation tasks is displayed in order of scheduled date and time.

3. The method according to claim 1, wherein the execution schedule is displayed for the user to identify the task in which the color validation has not been executed even though the task has passed the scheduled date and time, a task that has reached the scheduled date and time, and a task that has not yet reached the scheduled date and time.

4. The method according to claim 1, wherein the execution schedule is displayed for the user to identify whether the color validation is a pass or a fail based on the obtained execution result of the color validation.

5. The method according to claim 1, wherein the execution schedule is displayed for the user to identify a task of the color validation to be executed at a current time.

6. The method according to claim 1, wherein the execution schedule is displayed for each image forming apparatus.

7. A non-transitory computer-readable storage medium that stores one or more programs including instructions, which when executed by one or more processors of an information processing apparatus, cause the information processing apparatus to perform a control method, the control method comprising:
obtaining an execution result of color validation; and
displaying an execution schedule of the color validation,
wherein the execution schedule is displayed for a user to identify a color validation result and whether the color validation is executed based on the obtained execution result of the color validation, and the execution schedule is displayed for the user to identify a task in which the color validation has not been executed even though the task has passed a scheduled date and time.

8. An information processing apparatus comprising:
one or more memories that store instructions; and
one or more processors configured to execute the instructions stored in the one or more memories to:
obtain an execution result of color validation; and
display an execution schedule of the color validation,
wherein, in displaying, the execution schedule is displayed for a user to identify a color validation result and whether the color validation is executed based on the obtained execution result of the color validation, and the execution schedule is displayed for the user to identify a task in which the color validation has not been executed even though the task has passed a scheduled date and time.

9. The information processing apparatus according to claim 8, wherein the execution schedule is displayed such that a plurality of scheduled color validation tasks is displayed in order of scheduled date and time.

10. The information processing apparatus according to claim 8, wherein the execution schedule is displayed for the user to identify the task in which the color validation has not been executed even though the task has passed the scheduled date and time, a task that has reached the scheduled date and time, and a task that has not yet reached the scheduled date and time.

11. The information processing apparatus according to claim 8, wherein the execution schedule is displayed for the user to identify whether the color validation is a pass or a fail based on the obtained execution result of the color validation.

12. The information processing apparatus according to claim 8, wherein the execution schedule is displayed for the user to identify a task of the color validation to be executed at a current time.

13. The information processing apparatus according to claim 8, wherein the execution schedule is displayed for each image forming apparatus.
